(19) United States
(12) Patent Application Publication
(10) Pub. No.: US 2026/0230849 A1
(43) Pub. Date: Aug. 6, 2026

(54) MONITORING A PERFORMANCE OF A MACHINE LEARNING MODEL

(71) Applicant: Lenovo (United States) Inc., Morrisville, NC (US)

(72) Inventor: Venkata Srinivas Kothapalli, Aurora, IL (US)

(73) Assignee: Lenovo (United States) Inc., Morrisville, NC (US)

(21) Appl. No.: 19/047,039

(22) Filed: Feb. 6, 2025

(51) Int. Cl. H04W 24/02; H04B 17/318; H04W 24/10

(52) U.S. Cl. CPC H04W 24/02; H04B 17/328; H04W 24/10

(57) ABSTRACT

Various aspects of the present disclosure relate to monitoring a performance of a machine learning model. An apparatus, such as a UE or an NE, generates a set of probability values based on inputting unlabeled data in a machine learning model. In some examples, each probability value of the set of probability values indicates a probability that a respective label value is a label of at least a portion of the unlabeled data. Further, the apparatus generates a performance metric for the machine learning model based on the set of probability values and communicates in accordance with the performance metric.

### TECHNICAL FIELD

The present disclosure relates to wireless communications, and more specifically to monitoring a performance of a machine learning model.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

A device (e.g., a UE or an NE) for wireless communication is described. The device may be configured to, capable of, or operable to perform one or more operations as described herein. For example, the device may be configured to, capable of, or operable to generate a set of probability values based at least in part on inputting unlabeled data in a machine learning model, wherein each probability value of the set of probability values indicates a probability that a respective label value is a label of at least a portion of the unlabeled data; generate a performance metric for the machine learning model based at least in part on the set of probability values; and communicate in accordance with the performance metric.

A processor (e.g., a standalone processor chipset, or a component of the device (e.g., the UE or the NE)) for wireless communication is described. The processor may be configured to, capable of, or operable to perform one or more operations as described herein. For example, the processor may be configured to, capable of, or operable to generate a set of probability values based at least in part on inputting unlabeled data in a machine learning model, wherein each probability value of the set of probability values indicates a probability that a respective label value is a label of at least a portion of the unlabeled data; generate a performance metric for the machine learning model based at least in part on the set of probability values; and communicate in accordance with the performance metric.

A method performed or performable by the device (e.g., the UE or the NE) for wireless communication is described. The method may include generating a set of probability values based at least in part on inputting unlabeled data in a machine learning model, wherein each probability value of the set of probability values indicates a probability that a respective value is a label of at least a portion of the unlabeled data; generating a performance metric for the machine learning model based at least in part on the probability values; and communicating in accordance with the performance metric.

In some implementations of the device (e.g., the UE or the NE), the processor, and the method described herein, the device (e.g., the UE or the NE), the processor, and the method may further be configured to, capable of, operable to, performed to, or performable to generate a respective subset of probability values for each respective portion of the unlabeled data based at least in part on inputting the respective portions of the unlabeled data in the machine learning model; and generate an entropy value for each respective subset of probability values, wherein the performance metric is based at least in part on an average of the entropy values.

In some implementations of the device (e.g., the UE or the NE), the processor, and the method described herein, the device (e.g., the UE or the NE), the processor, and the method may further be configured to, capable of, operable to, performed to, or performable to scale the entropy values by one or more probability values associated with the unlabeled data, wherein the one or more probability values associated with the unlabeled data indicate a likelihood of the unlabeled data; or weight the entropy values by the one or more probability values associated with the unlabeled data.

In some implementations of the device (e.g., the UE or the NE), the processor, and the method described herein, the device (e.g., the UE or the NE), the processor, and the method may further be configured to, capable of, operable to, performed to, or performable to receive, from a second device, signaling indicating the one or more probability values associated with the unlabeled data. In some implementations of the device (e.g., the UE or the NE), the processor, and the method described herein, the entropy values are generated via Shannon entropy.

In some implementations of the device (e.g., the UE or the NE), the processor, and the method described herein, the device (e.g., the UE or the NE), the processor, and the method may further be configured to, capable of, operable to, performed to, or performable to receive, from a second device, signaling indicating the unlabeled data. In some implementations of the device (e.g., the UE or the NE), the processor, and the method described herein, the signaling comprises reference signaling.

In some implementations of the device (e.g., the UE or the NE), the processor, and the method described herein, the device (e.g., the UE or the NE), the processor, and the method may further be configured to, capable of, operable to, performed to, or performable to receive, from a second device, reference signaling; and measure the received reference signaling, wherein the unlabeled data is obtained based at least in part on the measurement. In some implementations of the device (e.g., the UE or the NE), the processor, and the method described herein, the measurement comprises one or more of a reference signal receive power (RSRP) value, a reference signal receive quality (RSRQ) value, a signal-to-noise ratio (SNR) value, a channel quality indicator (CQI) value, a modulation coding scheme (MCS) value, a precoding matrix indicator (PMI) value, or a rank value.

In some implementations of the device (e.g., the UE or the NE), the processor, and the method described herein, the device (e.g., the UE or the NE), the processor, and the method may further be configured to, capable of, operable to, performed to, or performable to detect a trigger event, wherein the performance metric is generated based at least in part on detecting the trigger event.

In some implementations of the device (e.g., the UE or the NE), the processor, and the method described herein, the device (e.g., the UE or the NE), the processor, and the method may further be configured to, capable of, operable to, performed to, or performable to transmit, to a second device, a report indicating the performance metric.

In some implementations of the device (e.g., the UE or the NE), the processor, and the method described herein, the device (e.g., the UE or the NE), the processor, and the method may further be configured to, capable of, operable to, performed to, or performable to compare the performance metric to a threshold, wherein the report is transmitted based at least in part on the performance metric satisfying the threshold.

In some implementations of the device (e.g., the UE or the NE), the processor, and the method described herein, the machine learning model comprises a classifier machine learning model that generates labels for the unlabeled data, the labels included in a set of one or more labels.

In some implementations of the device (e.g., the UE or the NE), the processor, and the method described herein, the unlabeled data comprises one or more of a scalar, a one-dimensional vector, or a matrix having two or more dimensions.

A device (e.g., a UE or an NE) for wireless communication is described. The device may be configured to, capable of, or operable to perform one or more operations as described herein. For example, the device may be configured to, capable of, or operable to generate an entropy value for unlabeled data based at least in part on a set of probability values generated for the unlabeled data using a machine learning model; generate a performance metric for the machine learning model based at least in part on the entropy value; and communicate in accordance with the performance metric.

A processor (e.g., a standalone processor chipset, or a component of the device (e.g., the UE or the NE)) for wireless communication is described. The processor may be configured to, capable of, or operable to perform one or more operations as described herein. For example, the processor may be configured to, capable of, or operable to generate an entropy value for unlabeled data based at least in part on a set of probability values generated for the unlabeled data using a machine learning model; generate a performance metric for the machine learning model based at least in part on the entropy value; and communicate in accordance with the performance metric.

A method performed or performable by the device (e.g., the UE or the NE) for wireless communication is described. The method may include generating an entropy value for unlabeled data based at least in part on a set of probability values generated for the unlabeled data using a machine learning model; generating a performance metric for the machine learning model based at least in part on the entropy value; and communicating in accordance with the performance metric.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIG. 3 illustrates an example of a flow diagram in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a device (e.g., a UE or an NE) in accordance with aspects of the present disclosure.

### DETAILED DESCRIPTION

Devices of a wireless communications system (e.g., a UE or an NE) may deploy one or more machine learning models to improve one or more operations. For example, a device of the wireless communications system may utilize a machine learning model to predict a best beam pair as part of a beam management procedure. To ensure that the machine learning model is operating properly, the device may monitor a performance of the machine learning model. Using a first technique, the device may monitor the performance of the machine learning model by inputting data samples with known labels (e.g., labeled data samples) into the machine learning model and comparing labels output from the machine learning model with the known labels. However, such technique may require the device to receive signaling indicating the labeled data sample which may result in significant overhead signaling.

Using a second technique, the device may monitor the performance of the machine learning model by tracking performance indices of the wireless communications system. For example, the device may detect that the machine learning is not functioning properly in response to determining that a performance of the wireless communications system is poor (e.g., a packet error rate is above a threshold). However, the performance of the wireless communications system may be affected by many other factors (e.g., imperfections in the transmission-reception link). Thus, to determine that the machine learning model is the cause of the decrease in performance of the wireless communications system, further analysis may be performed resulting in latency.

As described here, the device (e.g., the UE or the NE) of the wireless communications system may implement self-model monitoring (or autonomous model monitoring) which may decrease overhead signaling and latency when compared to other techniques of model monitoring. In some examples, the device may implement a machine learning model to perform one or more operations (e.g., beam management, channel state information (CSI) prediction, etc.). To monitor a performance of the machine learning model, the device may obtain unlabeled data (e.g., data with no known labels) and input the unlabeled data in the machine learning model. As an output, the machine learning model may generate a set of probability values associated with the unlabeled data. Each probability value may indicate a probability that a label value is a label for a respective portion of the unlabeled data.

Upon generating the set of probability values, the device may determine a performance metric for the machine learning model based on the set of probability values. More specifically, the device may determine an entropy value for the set of probability values and determine whether the machine learning model exhibits poor or good performance based on the entropy value satisfying a threshold. Upon determining the performance metric, the device may communicate in accordance with the performance metric (e.g., report the performance metric to another node and/or modify the machine learning model based on the performance metric).

By performing self-model monitoring in a wireless communications system as described herein, a device (e.g., a UE or an NE) may reduce latency or decrease signaling overhead when compared other techniques.

Aspects of the present disclosure are described in the context of a wireless communications system. Additional aspects of the present disclosure are described in the context of a flow diagram, component diagrams, and flowcharts.

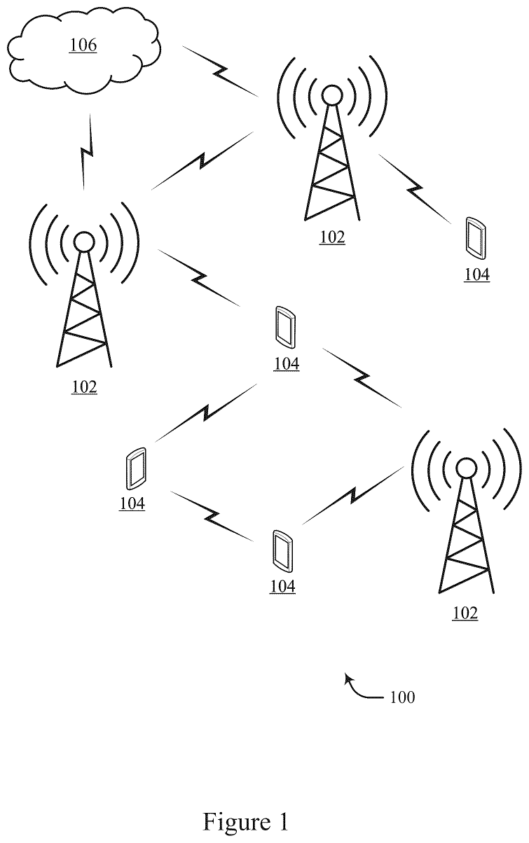

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, the wireless communications system 100 may adopt machine learning techniques or models to build more efficient modules in a transmission-reception chain of the wireless communications system 100. Machine learning models may perform various functions in the wireless communications system 100. For example, machine learning models may be used to enhance channel state information (CSI) compression, beam prediction, or positioning.

Machine learning models that predict a label value that is discrete in nature based on one or more input data samples is known as a classifier model. Many of the machine learning models used in the wireless communications system 100 may be classifier models or may be trained as classifier models. Examples of classifier models implemented by the wireless communications system may include a machine learning model for beam prediction or a machine learning model for predicting a CQI, a rank indicator (RI), or an MCS index.

The following describes a functionality of a machine learning model that may be implemented by devices of the wireless communications system 100. In some examples, xᵢ∈ [symbol] and yᵢ∈ [symbol] may denote an input data sample and a label, respectively. xᵢ and yᵢ may be a scalar or a one or multi-dimensional vector. Additionally, [symbol] and [symbol] may denote the input sample space and the output sample space, respectively.

When yᵢ assumes finitely many values (i.e., when | [symbol] |, the cardinality of the set y is finite), the machine learning model is known as a classifier model. When yᵢ assumes continuous values (i.e., when [symbol] ⊆ [symbol] and | [symbol] |=∞), the machine learning model is known as a regression model. The machine learning model may be a function, ƒ_{θ}, where ƒ_{θ}: [symbol] > [symbol] . Here, θ∈Θ may denote a set of model parameters that may be learned during the process of training the machine learning model. Determining optimal values for the model parameters may be referred to as “training the model” or “learning the model”. The general procedure of developing the machine learning model includes minimizing a loss function based on a training data set that includes either labelled data samples or unlabeled data samples resulting in supervised learning or unsupervised learning, respectively.

Classifier models may be probabilistic and therefore, generate a probability distribution over the predictions made by the classifier model. The probability distribution may be conditioned on the input data samples and parameterized by θ. Thus, the classifier model may generate the probability distribution P(y|x; θ). As the parameters of the model are fixed at the end of training, θ may be dropped and P(y|x) may denote the probability distribution over the predictions, conditioned on the input data samples, generated by the classifier model.

In one example, y may be a discrete variable with y∈{1, . . . , M} and P(y|x) may be the probability that y is the predicted label for x as per the machine learning model ƒ_{θ}. In other words, P(y_{c}|xᵢ) is the probability that y_{c} is the label for the given input data sample xᵢ, as per the prediction made by the machine learning model f_{θ}. Note that

$${\sum }_{c = 1}^{M} P ( {y}_{c} \vert {x}_{i} ) = 1 ,$$

or, equivalently, [symbol] P(y_{c}|xᵢ)=1, where [symbol] ={1, . . . , M}.

When deployed in the field, the machine learning models (or classifier models) may be expected to perform with a same level of performance or accuracy by providing desired inferences or predictions as seen during a training phase of the machine learning models. However, while operating in the field, machine learning models may make predictions or inferences based on data having different statistical characteristics than data over which the machine learning models are trained which may result in the machine learnings models outputting erroneous or wrong inferences or predictions. Further, the machine learning model may drift due to imperfections in hardware implementing the machine learning model. Thus, devices of the wireless communications system 100 may deploy model monitoring techniques to monitor a performance of the machine learning models employed by the wireless communications system 100. It is worth noting that model monitoring may not be a one-time or an occasional task. As data distributions change due to a time-varying nature of physical propagation medium or other network parameters, model monitoring may be performed in a continual manner.

Using a first technique of model monitoring, the device hosting the machine model (e.g., the NE 102 or the UE 104) may receive a labeled data sample (x,y), where x may be an input data sample and y may be the corresponding label. By giving x as input to the machine learning model and observing the output of the machine learning model, the node may determine the performance of the machine learning model. In some examples, the device may repeat the above steps for multiple labeled data samples to obtain a more accurate performance of the machine learning models. Labeled data samples may be examples of reference signals. For example, if the device receives a CSI reference signal (CSI-RS), the device knows the symbol encoded in the CSI-RS and thus, the CSI-RS may serve as a labelled data sample for channel equalization. However, this technique of model monitoring may require one or more labelled data samples to be sent to the device resulting in additional overhead signaling.

Using a second technique of model monitoring, the device may determine a performance of the machine learning model based on a performance of the wireless communications system 100. When the machine learning model being used to perform a particular task in the wireless communications system 100 starts performing poorly, the wireless communications system's performance will get effected. For example, when a machine learning model for channel estimation deviates from a desired performance, the error probability (or error rate (e.g., block error rate (BLER) or packet error rate)) increases leading to a higher number of retransmissions or a subsequent degradation in a quality of service. Similarly, when a performance of a machine learning model for predicting RSRP values for beams from a few beam measurements degrades, the device may select a wrong beam resulting in a less-reliable wireless link or a link-failure. However, the performance of the wireless communications system 100 may degrade due to multiple factors. For example, a higher BLER may be due to other imperfections in the transmission-reception link. Thus, a deeper analysis may be performed in order to determine the cause of a decrease in performance of the wireless communications system 100 incurring more latency.

Thus, it may be desirable to have a more efficient mechanism available at the device for monitoring the performance of machine learning models. According to implementations, one or more of the NEs 102 and the UEs 104 are operable to implement various aspects of the techniques described with reference to the present disclosure. For example, a device (e.g., the NE 102 or the UE 104) may generate a set of probability values (e.g., a probability distribution) based on inputting unlabeled data in a machine learning model. In some examples, each probability value of the set indicates a probability that a respective label value is a label of at least a portion of the unlabeled data. Further, the device may generate a performance metric for the machine learning model based on the set of probability values and communicate in accordance with the performance metric. Using the method as described herein, the device may monitor performance of machine learning models with decreased signaling and latency as compared to other methods of machine learning model monitoring.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

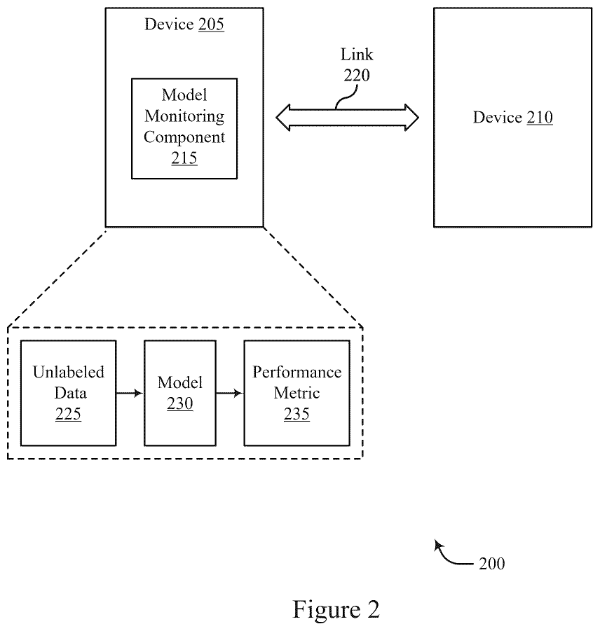

FIG. 2 illustrates an example of a wireless communications system 200 in accordance with aspects of the present disclosure. In some examples, the wireless communications system 200 may implement aspects of the wireless communications system 100. For example, the wireless communications system 200 may include a device 205 and a device 210 which may be examples of the NE 102 or the UE 104 as described with reference to FIG. 1.

In some examples, the device 205 (e.g., an NE or a UE) of the wireless communications system 200 may implement a machine learning model 230 to improve one or more tasks performed by the device 205. For example, the device 205 may implement the machine learning model 230 to estimate transmitted messages, symbols or bits from channel output signals, predict best beams or a set of usable beams from input data samples (e.g., a set of beam measurements or assistance information), predict best beams or a set of usable beams for future time slots from the input data samples, or predict CSI (e.g., CQI, RI, or PMI). In some examples, the machine learning model 230 may be an example of a classifier model. That is, the machine learning model 230 may output a label value (or a discrete value) selected from a set (or a finite number) of discrete values based on an input data sample.

As described herein, the device 205 may perform self-model monitoring. To perform self-model monitoring, the device 205 may include a model monitoring component 215 that is configured to monitor a performance metric 235 of the machine learning model 230 over time. In some examples, the model monitoring component 215 may perform the self-model monitoring in one or both of a periodic manner or an aperiodic manner. For example, the model monitoring component 215 may perform the self-model monitoring during one or more periodic intervals. Alternatively, or additionally, the model monitoring component 215 may perform the self-model monitoring in response to detecting one or more trigger events. In some examples, the one or more trigger events may include receiving signaling from another device (e.g., the device 210 via a link 220) requesting for the device 205 to perform the self-model monitoring or a performance metric associated with the wireless communications system 200 satisfying a threshold (e.g., an error rate exceeding a threshold).

As a part of self-model monitoring, the model monitoring component 215 may obtain unlabeled data 225 (or input data samples with no known labels). In some examples, the model monitoring component 215 may obtain the unlabeled data 225 via signaling (e.g., reference signaling) received from another device (e.g., the device 210 via the link 220). For example, the model monitoring component 215 may receive reference signaling from another device and determine the unlabeled data 225 based on measurements of the reference signaling (e.g., RSRP, RSRQ, SNR, CQI, MCS, or PMI). In some examples, upon obtaining the unlabeled data 225, the model monitoring component 215 may identify that the unlabeled data 225 corresponds to the machine learning model 230. The unlabeled data 225 may include one or more of a scalar, a one-dimensional vector, or a matrix having two or more dimensions.

Further, as part of self-model monitoring, the model monitoring component 215 may input the unlabeled data 225 in the machine learning model 230. The machine learning model 230 may analyze the unlabeled data 225 and output a set of probability values. In some examples, the set of probability values may include one or more subsets of probability values that each correspond to a respective portion of the unlabeled data 225 (e.g., an input data sample). Each probability value of a subset of probability values may indicate a probability that a label value (or a discrete value) is a label for a given portion of the unlabeled data 225. That is, for each portion of the unlabeled data 225, the machine learning model 230 may generate a respective probability distribution.

Using the probability values, the model monitoring component 215 may generate the performance metric 235 for the machine learning model 230. As a first step, the model monitoring component 215 may generate an entropy value for each of subset of probability values. In some examples, the entropy values may be generated via Shannon entropy. As a second step, the model monitoring component 215 may weight (or scale) the entropy values by probability values associated with the unlabeled data. In some examples, the probability values may include a probability value for each portion of the unlabeled data 225 that indicates a likelihood of a respective portion of the unlabeled data 225. In some examples, the probability value of each portion of unlabeled data 225 may be equal to a reciprocal of a total number of portions of the unlabeled data 225. Alternatively, the probability value of each portion of unlabeled data may be different. In some examples, the device 205 may determine the probability values of the unlabeled data 225 without signaling from another device. In another example, the device 205 may receive signaling from another device (e.g., the device 210 via the link 220) indicating the probability values of the unlabeled data 225.

As a third step, the model monitoring component 215 may determine an average entropy value of the unlabeled data 225. That is, the model monitoring component 215 may sum the entropy values and divide the sum by the number of portions of the unlabeled data 225. In some examples, the average entropy value may be representative of the performance metric 235 for the machine learning model 230. For example, if the average entropy value is low (or below a threshold), the performance metric 235 may indicate that the machine learning model is performing accurately or reliably. Alternatively, if the average entropy value is high (or above the threshold), the performance metric 235 may indicate that the machine learning model is performing inaccurately or unreliably.

As a fourth step, the model monitoring component 215 may perform one or more actions in response to determining the performance metric. The one or more actions may include transmitting a report including the performance metric 235 to one or more other devices (e.g., the device 210 via the link 220) or, if the performance metric 235 indicates poor performance, the one or more actions may include retraining the machine learning model 230, fine-tuning the machine learning model 230, switching the machine learning model 230 with another model, or deactivating the machine learning model 230.

Using the methods as described herein, the device 205 may monitor its own machine learning model 230 without requiring additional signaling from another device. Further, it should be understood that self-model monitoring may be used alone or in conjunction with other model monitoring techniques (e.g., labeled data samples, reference signals, or any other side or assistance information).

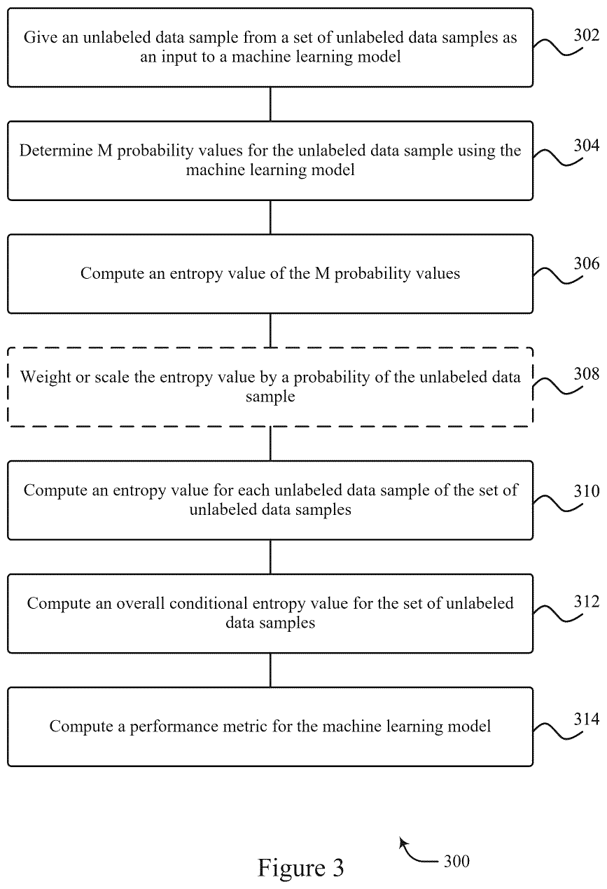

FIG. 3 illustrates an example flow diagram 300 in accordance with aspects of the present disclosure. In some examples, the flow diagram 300 may be implemented by aspects of the wireless communications system 100 or the wireless communications system 200. For example, the flow diagram 300 may be implemented by the UE 104 or the NE 102 as described with reference to FIG. 1. Additionally, or alternatively, the flow diagram 300 may be implemented by the device 205 as described with reference to FIG. 2.

At 302, a device (e.g., a NE or a UE) may give an unlabeled data sample, xᵢ, from a set of unlabeled data samples (e.g., i=1, . . . , n) as an input to a machine learning model, ƒ_{θ} (e.g., a classifier machine learning model).

At 304, the device may determine M probability values (or a probability distribution) for the unlabeled data sample using the machine learning model, ƒ_{θ}, which may be illustrated by Equation 1. In some examples, the machine learning model, ƒ_{θ}, may produce a conditional probability distribution that is differentiable in θ which may be illustrated by Equation 2.

$$P ( y \vert {x}_{i} ) \qquad ( 1 )$$

$$P ( y \vert {x}_{i} ; θ ) \qquad ( 2 )$$

At 306, the device may compute an entropy value of the M probability values (or the probability distribution) for the unlabeled data sample which may be illustrated by Equation 3.

$$H ( P ( y \vert {x}_{i} ; θ ) ) \qquad ( 3 )$$

At 308, the device may potentially weight or scale the entropy value of the unlabeled data sample by a probability of the unlabeled data sample, P(xᵢ), which may be illustrated by Equation 4. The probability of the unlabeled sample may indicate a likelihood of the unlabeled data sample. In some examples, the probability of the unlabeled sample may be based on a set of training data samples used to train the machine learning model. If the unlabeled data samples of the set are equally likely, the device may not consider the probability of the unlabeled sample.

$$P ( {x}_{i} ) H ( P ( y \vert {x}_{i} ; θ ) ) \qquad ( 4 )$$

At 310, the device may repeat one or more of steps 304-308 for each unlabeled data sample of the set of unlabeled data samples. That is, the device may compute an entropy value or a weighted entropy value for each unlabeled data sample of the set of unlabeled data samples. In some examples, the set of unlabeled data samples may include more than two unlabeled data samples. One or two data samples may not be enough for the device to accurately predict the performance of the machine learning model with high confidence.

At 312, the device may compute an overall conditional entropy value, H(P(y|x; θ)), for the set of unlabeled data samples. In some examples, if the set of unlabeled data samples are equally likely, the device may compute the overall conditional entropy value as an average of the entropy values (as determined by Equation 3) which may be illustrated in Equation 5. Alternatively, the device may compute the overall conditional entropy value as a sum of the entropy values (as determined by Equation 3 or Equation 4) which may be illustrated in Equation 6. In some examples, the logarithm (log) may be a base natural logarithm, or a base-2 logarithm.

$$\frac{1}{n} {\sum }_{i = 1}^{n} H ( P ( y \vert {x}_{i} ; θ ) ) = - \frac{1}{n} {\sum }_{i = 1}^{n} {\sum }_{{y}_{c} ∈ ℳ} P ( {y}_{c} \vert {x}_{i} ; θ ) log P ( {y}_{c} \vert {x}_{i} ; θ ) \qquad ( 5 )$$

$${\sum }_{i = 1}^{n} P ( {x}_{i} ) H ( P ( y \vert {x}_{i} ; θ ) ) \qquad ( 6 )$$

At 314, the device may compute a performance metric for the machine learning model. In some examples, the device may compute the performance metric for the machine learning mode based on the overall conditional entropy value, H(P(y|x; θ)) (e.g., as determined by Equation 5 or 6). For example, the device may determine that the machine learning model has a good (or better or acceptable) performance if the overall conditional entropy value is a low value (or below a threshold). Alternatively, the device may determine that the machine learning model has bad (or worse or unacceptable) performance if the overall conditional entropy value is a high value (or above the threshold).

Example reasoning that the performance metric may be equal to the overall conditional entropy includes the following: For an input data sample, the value of H(P(y|xᵢ; θ)) indicates the confidence of the machine learning models' prediction on the input data sample. This is because H(P(y|xᵢ; θ)) is equal to 0 if P(y|xᵢ; θ) is equal to 1 for any value of y_{c}. On the other hand, H(P(y|xᵢ; θ)) would achieve its highest value of

$$\frac{1}{M} log M when P ( {y}_{c} \vert {x}_{i} ; θ ) = \frac{1}{M}$$

for possible values of y_{c}, i.e., for y_{c}∈ [symbol] ={1, . . . , M}. Thus, when the machine learning model confidently predicts a label for the input data sample and puts the probability mass on that label, H(P(y|xᵢ; θ)) will have a low value. When the machine learning model assigns equal probability value to the possible labels for the input data sample, it means that the machine learning model has least confidence on its prediction and, in such a case, H(P(y|xᵢ; θ)) will reach maximum possible value.

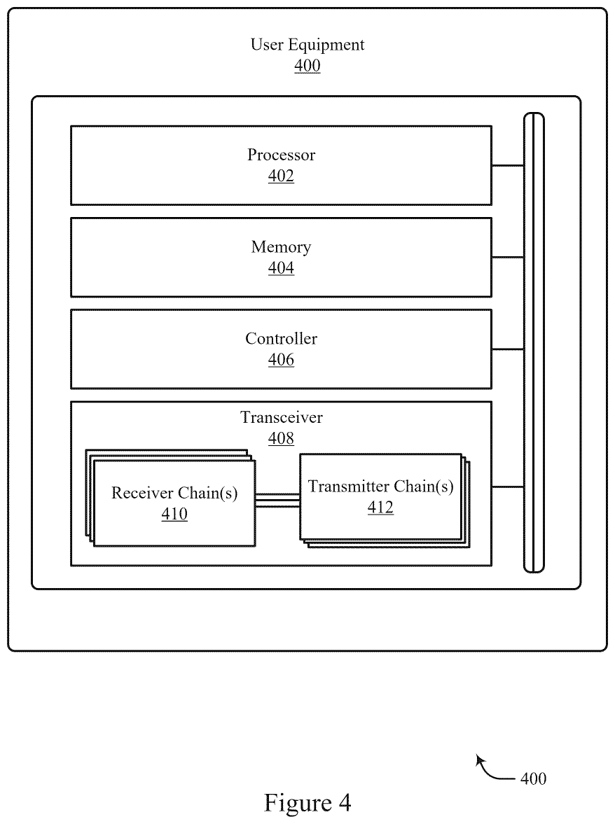

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for generating a set of probability values based at least in part on inputting unlabeled data in a machine learning model, wherein each probability value of the set of probability values indicates a probability that a respective value is a label of at least a portion of the unlabeled data; generating a performance metric for the machine learning model based at least in part on the probability values; and communicating in accordance with the performance metric.

Additionally, the UE 400 may be configured to support any one or combination of generating a respective subset of probability values for each respective portion of the unlabeled data based at least in part on inputting the respective portions of the unlabeled data in the machine learning model; and generating an entropy value for each respective subset of probability values, wherein the performance metric is based at least in part on an average of the entropy values.

Moreover, the UE 400 may be configured to or operable to support a means for generating an entropy value for unlabeled data based at least in part on a set of probability values generated for the unlabeled data using a machine learning model; generate a performance metric for the machine learning model based at least in part on the entropy value; and communicating in accordance with the performance metric.

Additionally, or alternatively, the UE 400 may support at least one memory (e.g., the memory 404) and at least one processor (e.g., the processor 402) coupled with the at least one memory and configured to cause the UE 400 to generate a set of probability values based at least in part on inputting unlabeled data in a machine learning model, wherein each probability value of the set of probability values indicates a probability that a respective value is a label of at least a portion of the unlabeled data; generate a performance metric for the machine learning model based at least in part on the probability values; and communicate in accordance with the performance metric.

Additionally, the UE 400 may be configured to support any one or combination of the at least one processor configured to cause the UE 400 to generate a respective subset of probability values for each respective portion of the unlabeled data based at least in part on inputting the respective portions of the unlabeled data in the machine learning model; and generate an entropy value for each respective subset of probability values, wherein the performance metric is based at least in part on an average of the entropy values.

Additionally, the UE 400 may be configured to support any one or combination of the at least one processor configured to cause the UE 400 to scale the entropy values by one or more probability values associated with the unlabeled data, wherein the one or more probability values associated with the unlabeled data indicate a likelihood of the unlabeled data; or weight the entropy values by the one or more probability values associated with the unlabeled data.

Additionally, the UE 400 may be configured to support any one or combination of the at least one processor configured to cause the UE 400 to receive, from a second device, signaling indicating the one or more probability values associated with the unlabeled data. In some examples, the entropy values are generated via Shannon entropy.

Additionally, the UE 400 may be configured to support any one or combination of the at least one processor configured to cause the UE 400 to receive, from a second device, signaling indicating the unlabeled data. In some examples, the signaling comprises reference signaling. Additionally, the UE 400 may be configured to support any one or combination of the at least one processor configured to cause the UE 400 to receive, from a second device, reference signaling; and measure the received reference signaling, wherein the unlabeled data is obtained based at least in part on the measurement. In some examples, the measurement comprises one or more of an RSRP value, an RSRQ value, an SNR value, a CQI value, an MCS value, a PMI value, or a rank value.

Additionally, the UE 400 may be configured to support any one or combination of the at least one processor configured to cause the UE 400 to detect a trigger event, wherein the performance metric is generated based at least in part on detecting the trigger event. Additionally, the UE 400 may be configured to support any one or combination of the at least one processor configured to cause the UE 400 to transmit, to a second device, a report indicating the performance metric.

Additionally, the UE 400 may be configured to support any one or combination of the at least one processor configured to cause the UE 400 to compare the performance metric to a threshold, wherein the report is transmitted based at least in part on the performance metric satisfying the threshold.

In some examples, the machine learning model comprises a classifier machine learning model that generates labels for the unlabeled data, the labels included in a set of one or more labels. In some examples, the unlabeled data comprises one or more of a scalar, a one-dimensional vector, or a matrix having two or more dimensions.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

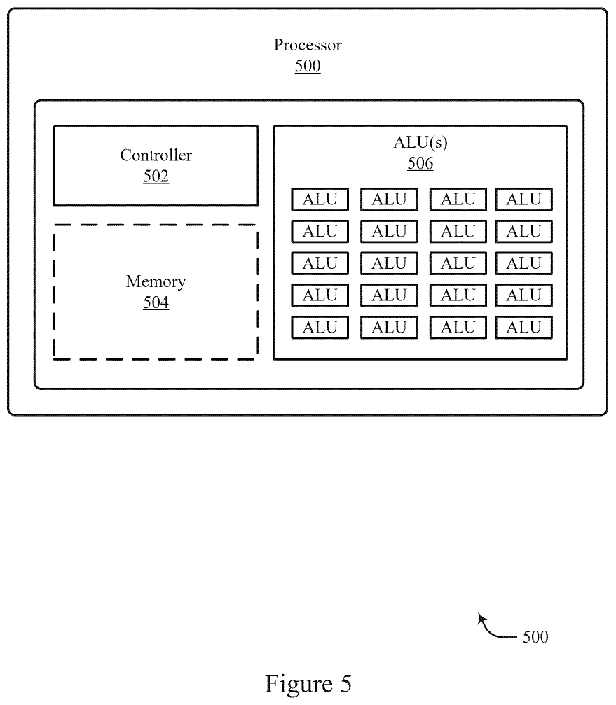

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to generate a set of probability values based at least in part on inputting unlabeled data in a machine learning model, wherein each probability value of the set of probability values indicates a probability that a respective value is a label of at least a portion of the unlabeled data; generate a performance metric for the machine learning model based at least in part on the probability values; and communicate in accordance with the performance metric

Additionally, the processor 500 may be configured to or operable to generate a respective subset of probability values for each respective portion of the unlabeled data based at least in part on inputting the respective portions of the unlabeled data in the machine learning model; and generate an entropy value for each respective subset of probability values, wherein the performance metric is based at least in part on an average of the entropy values.

Additionally, the processor 500 may be configured to or operable to scale the entropy values by one or more probability values associated with the unlabeled data, wherein the one or more probability values associated with the unlabeled data indicate a likelihood of the unlabeled data; or weight the entropy values by the one or more probability values associated with the unlabeled data.

Additionally, the processor 500 may be configured to or operable to receive, from a second device, signaling indicating the one or more probability values associated with the unlabeled data. In some examples, the entropy values are generated via Shannon entropy. Additionally, the processor 500 may be configured to or operable to receive, from a second device, signaling indicating the unlabeled data. In some examples, the signaling comprises reference signaling.

Additionally, the processor 500 may be configured to or operable to receive, from a second device, reference signaling; and measure the received reference signaling, wherein the unlabeled data is obtained based at least in part on the measurement. In some examples, the measurement comprises one or more of an RSRP value, an RSRQ value, an SNR value, a CQI value, an MCS value, a PMI value, or a rank value. Additionally, the processor 500 may be configured to or operable to detect a trigger event, wherein the performance metric is generated based at least in part on detecting the trigger event.

Additionally, the processor 500 may be configured to or operable to transmit, to a second device, a report indicating the performance metric. Additionally, the processor 500 may be configured to or operable to compare the performance metric to a threshold, wherein the report is transmitted based at least in part on the performance metric satisfying the threshold.

In some examples, the machine learning model comprises a classifier machine learning model that generates labels for the unlabeled data, the labels included in a set of one or more labels. In some examples, the unlabeled data comprises one or more of a scalar, a one-dimensional vector, or a matrix having two or more dimensions.

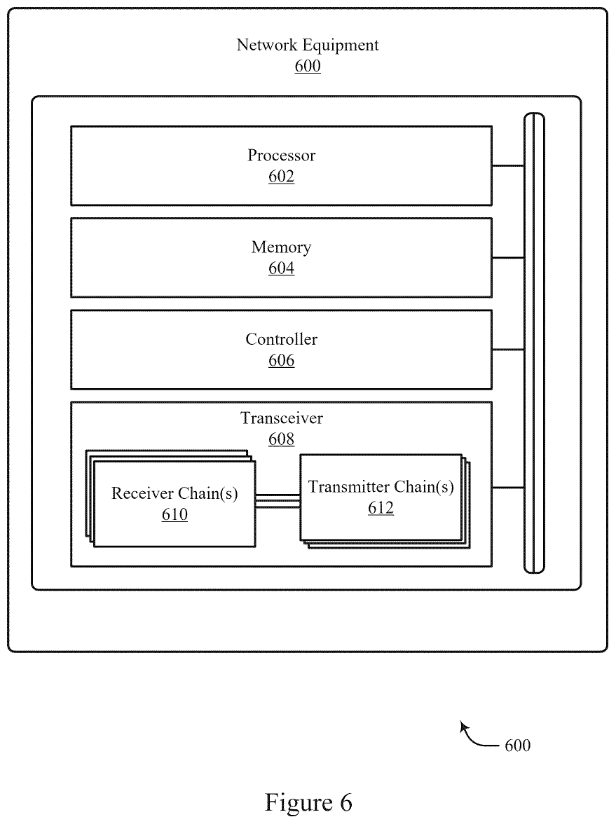

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for generating a set of probability values based at least in part on inputting unlabeled data in a machine learning model, wherein each probability value of the set of probability values indicates a probability that a respective value is a label of at least a portion of the unlabeled data; generating a performance metric for the machine learning model based at least in part on the probability values; and communicating in accordance with the performance metric.

Additionally, the NE 600 may be configured to support any one or combination of generating a respective subset of probability values for each respective portion of the unlabeled data based at least in part on inputting the respective portions of the unlabeled data in the machine learning model; and generating an entropy value for each respective subset of probability values, wherein the performance metric is based at least in part on an average of the entropy values.

Moreover, the NE 600 may be configured to or operable to support a means for generating an entropy value for unlabeled data based at least in part on a set of probability values generated for the unlabeled data using a machine learning model; generate a performance metric for the machine learning model based at least in part on the entropy value; and communicating in accordance with the performance metric.

Additionally, or alternatively, the NE 600 may support at least one memory (e.g., the memory 604) and at least one processor (e.g., the processor 602) coupled with the at least one memory and configured to cause the NE 600 to generate a set of probability values based at least in part on inputting unlabeled data in a machine learning model, wherein each probability value of the set of probability values indicates a probability that a respective value is a label of at least a portion of the unlabeled data; generate a performance metric for the machine learning model based at least in part on the probability values; and communicate in accordance with the performance metric.

Additionally, the NE 600 may be configured to support any one or combination of the at least one processor configured to cause the NE 600 to generate a respective subset of probability values for each respective portion of the unlabeled data based at least in part on inputting the respective portions of the unlabeled data in the machine learning model; and generate an entropy value for each respective subset of probability values, wherein the performance metric is based at least in part on an average of the entropy values.

Additionally, the NE 600 may be configured to support any one or combination of the at least one processor configured to cause the NE 600 to scale the entropy values by one or more probability values associated with the unlabeled data, wherein the one or more probability values associated with the unlabeled data indicate a likelihood of the unlabeled data; or weight the entropy values by the one or more probability values associated with the unlabeled data.

Additionally, the NE 600 may be configured to support any one or combination of the at least one processor configured to cause the NE 600 to receive, from a second device, signaling indicating the one or more probability values associated with the unlabeled data. In some examples, the entropy values are generated via Shannon entropy.

Additionally, the NE 600 may be configured to support any one or combination of the at least one processor configured to cause the NE 600 to receive, from a second device, signaling indicating the unlabeled data. In some examples, the signaling comprises reference signaling. Additionally, the NE 600 may be configured to support any one or combination of the at least one processor configured to cause the NE 600 to receive, from a second device, reference signaling; and measure the received reference signaling, wherein the unlabeled data is obtained based at least in part on the measurement. In some examples, the measurement comprises one or more of an RSRP value, an RSRQ value, an SNR value, a CQI value, an MCS value, a PMI value, or a rank value.

Additionally, the NE 600 may be configured to support any one or combination of the at least one processor configured to cause the NE 600 to detect a trigger event, wherein the performance metric is generated based at least in part on detecting the trigger event. Additionally, the NE 600 may be configured to support any one or combination of the at least one processor configured to cause the NE 600 to transmit, to a second device, a report indicating the performance metric.

Additionally, the NE 600 may be configured to support any one or combination of the at least one processor configured to cause the NE 600 to compare the performance metric to a threshold, wherein the report is transmitted based at least in part on the performance metric satisfying the threshold.

In some examples, the machine learning model comprises a classifier machine learning model that generates labels for the unlabeled data, the labels included in a set of one or more labels. In some examples, the unlabeled data comprises one or more of a scalar, a one-dimensional vector, or a matrix having two or more dimensions.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

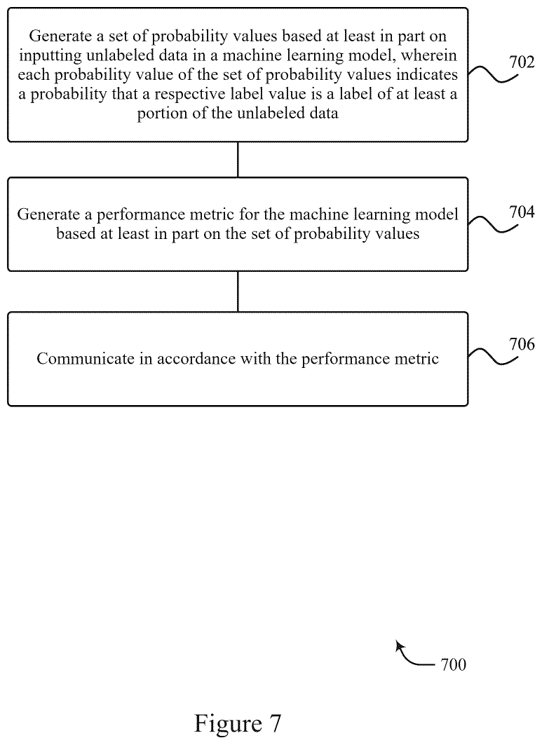

FIG. 7 illustrates a flowchart of a method 700 in accordance with aspects of the present disclosure. The operations of the method may be implemented by a device (e.g., a UE or an NE) as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 702, the method may include generating a set of probability values based at least in part on inputting unlabeled data in a machine learning model, wherein each probability value of the set of probability values indicates a probability that a respective value is a label of at least a portion of the unlabeled data. The operations of 702 may be performed in accordance with examples as described herein. In some implementations, aspects of the operations of 702 may be performed by a UE as described with reference to FIG. 4 or an NE as described with reference to FIG. 6.

At 704, the method may include generating a performance metric for the machine learning model based at least in part on the probability values. The operations of 704 may be performed in accordance with examples as described herein. In some implementations, aspects of the operations of 704 may be performed by a UE as described with reference to FIG. 4 or an NE as described with reference to FIG. 6.

At 706, the method may include communicating in accordance with the performance metric. The operations of 706 may be performed in accordance with examples as described herein. In some implementations, aspects of the operations of 706 may be performed by a UE as described with reference to FIG. 4 or an NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first device for wireless communication, comprising:
at least one memory; and
at least one processor coupled with the at least one memory and configured to cause the first device to:
generate a set of probability values based at least in part on inputting unlabeled data in a machine learning model, wherein each probability value of the set of probability values indicates a probability that a respective label value is a label of at least a portion of the unlabeled data;
generate a performance metric for the machine learning model based at least in part on the set of probability values; and
communicate in accordance with the performance metric.

2. The first device of claim 1, wherein the at least one processor is configured to cause the first device to:
generate a respective subset of probability values for each respective portion of the unlabeled data based at least in part on inputting the respective portions of the unlabeled data in the machine learning model; and
generate an entropy value for each respective subset of probability values, wherein the performance metric is based at least in part on an average of the entropy values.

3. The first device of claim 2, wherein the at least one processor is configured to cause the first device to:
scale the entropy values by one or more probability values associated with the unlabeled data, wherein the one or more probability values associated with the unlabeled data indicate a likelihood of the unlabeled data; or
weight the entropy values by the one or more probability values associated with the unlabeled data.

4. The first device of claim 3, wherein the at least one processor is configured to cause the first device to:
receive, from a second device, signaling indicating the one or more probability values associated with the unlabeled data.

5. The first device of claim 2, wherein the entropy values are generated via Shannon entropy.

6. The first device of claim 1, wherein the at least one processor is configured to cause the first device to:
receive, from a second device, signaling indicating the unlabeled data.

7. The first device of claim 6, wherein the signaling comprises reference signaling.

8. The first device of claim 1, wherein the at least one processor is configured to cause the first device to:
receive, from a second device, reference signaling; and
measure the received reference signaling, wherein the unlabeled data is obtained based at least in part on the measurement.

9. The first device of claim 8, wherein the measurement comprises one or more of a reference signal receive power (RSRP) value, a reference signal receive quality (RSRQ) value, a signal-to-noise ratio (SNR) value, a channel quality indicator (CQI) value, a modulation coding scheme (MCS) value, a precoding matrix indicator (PMI) value, or a rank value.

10. The first device of claim 1, wherein the at least one processor is configured to cause the first device to:
detect a trigger event, wherein the performance metric is generated based at least in part on detecting the trigger event.

11. The first device of claim 1, wherein the at least one processor is configured to cause the first device to:
transmit, to a second device, a report indicating the performance metric.

12. The first device of claim 11, wherein the at least one processor is configured to cause the first device to:
compare the performance metric to a threshold, wherein the report is transmitted based at least in part on the performance metric satisfying the threshold.

13. The first device of claim 1, wherein the machine learning model comprises a classifier machine learning model that generates labels for the unlabeled data, the labels included in a set of one or more labels.

14. The first device of claim 1, wherein the unlabeled data comprises one or more of a scalar, a one-dimensional vector, or a matrix having two or more dimensions.

15. A processor for wireless communication, comprising:
at least one controller coupled with at least one memory and configured to cause the processor to:
generate a set of probability values based at least in part on inputting unlabeled data in a machine learning model, wherein each probability value of the set of probability values indicates a probability that a respective value is a label of at least a portion of the unlabeled data;
generate a performance metric for the machine learning model based at least in part on the set of probability values; and
communicate in accordance with the performance metric.

16. The processor of claim 15, wherein the at least one controller is configured to cause the processor to:
generate a respective subset of probability values for each respective portion of the unlabeled data based at least in part on inputting the respective portions of the unlabeled data in the machine learning model; and
generate an entropy value for each respective subset of probability values, wherein the performance metric is based at least in part on an average of the entropy values.

17. The processor of claim 15, wherein the at least one controller is configured to cause the processor to:
receive signaling indicating the unlabeled data.

18. A method performed by a device, the method comprising:
generating a set of probability values based at least in part on inputting unlabeled data in a machine learning model, wherein each probability value of the set of probability values indicates a probability that a respective value is a label of at least a portion of the unlabeled data;
generating a performance metric for the machine learning model based at least in part on the probability values; and
communicating in accordance with the performance metric.

19. The method of claim 18, further comprising:
generating a respective subset of probability values for each respective portion of the unlabeled data based at least in part on inputting the respective portions of the unlabeled data in the machine learning model; and
generating an entropy value for each respective subset of probability values, wherein the performance metric is based at least in part on an average of the entropy values.

20. A first device for wireless communication, comprising:
at least one memory; and
at least one processor coupled with the at least one memory and configured to cause the first device to:
generate an entropy value for unlabeled data based at least in part on a set of probability values generated for the unlabeled data using a machine learning model;
generate a performance metric for the machine learning model based at least in part on the entropy value; and
communicate in accordance with the performance metric.
